(19) United States
(12) Patent Application Publication
(10) Pub. No.: US 2024/0346294 A1
(43) Pub. Date: Oct. 17, 2024

(54) DATA PROCESSING METHOD FOR A CONVOLUTIONAL NEURAL NETWORK

(71) Applicant: Montage Technology, Inc., San Jose, CA (US)

(72) Inventors: Guoheng WEI, San Jose, CA (US); Ming LI, San Jose, CA (US); Longfei TAI, San Jose, CA (US)

(21) Appl. No.: 18/301,272

(22) Filed: Apr. 17, 2023

(51) Int. Cl. G06N 3/0464; G06F 13/28

(52) U.S. Cl. CPC G06N 3/0464; G06F 13/28; G06F 2213/28

(57) ABSTRACT

A data processing method for a convolutional neural network, which includes a first and a second convolutional layer, wherein an output tensor of the first convolutional layer is used as a weight matrix for the second convolutional layer. The method includes: setting the first convolutional layer to a batch convolution mode, and configuring a parameter of a batch convolution operation and parameters of an input tensor of the first convolutional layer, wherein the configuring comprises: configuring the parameter of the batch convolution operation based on a first parameter of the weight matrix, and configuring the parameters of the input tensor based on a second parameter of the weight matrix and a first parameter of DMAs; and performing batch convolution operation to the configured input tensor, and configuring output parameters of the first convolutional layer based on a third parameter of the weight matrix and a second parameter of the DMAs.

### TECHNICAL FIELD

This application relates to neural network technology, and more specifically, to a data processing method for a convolutional neural network.

### BACKGROUND OF THE INVENTION

Various neural network techniques, including convolutional neural networks, have been widely used in various application scenarios and computing systems. In a convolutional neural network, data is mainly stored in the form of tensors, which need to be subjected to multiple convolution operations to achieve feature extraction.

In some processing methods, output feature maps of the result of a previous convolution operation are usually used as a weight matrix for a subsequent convolution operation for the subsequent convolution operation. However, in the hardware architecture of artificial intelligence (AI) accelerators, the distribution format of the output feature maps and the weight matrix in hardware may not be the same. Therefore, before using the output feature maps of the previous convolution operation as the weight matrix for the subsequent convolution operation, the format of the output feature maps of the previous convolution operation needs to be converted to the format of the weight matrix. In the conventional AI accelerator processing flow, the format conversion operation is usually performed with the help of hardware (e.g. direct memory accesses DMAs), that is, the output feature maps are read from on-chip memory (e.g. SRAM) to the hardware, and the data is re-organized in the hardware, and then, the re-organized data is written into memory. However, the read and write operations of the SRAM and the data reorganization of the DMAs are not only inefficient but also affect the utilization rate of SRAM, occupying hardware resources and time resources, resulting in a significant decrease in chip performance.

In view of this, there is a need for an improved data processing method suitable for convolutional neural networks.

### SUMMARY OF THE INVENTION

One of the objectives of the present application is to provide a data processing method for a convolutional neural network.

According to one aspect of the present application, a data processing method for a convolutional neural network is provided. The convolutional neural network comprises a first convolutional layer and a second convolutional layer, wherein an output tensor of the first convolutional layer is used as a weight matrix for the second convolutional layer. The data processing method comprising: setting the first convolutional layer to a batch convolution mode, and configuring a parameter of a batch convolution operation and parameters of an input tensor to be processed by the first convolutional layer, wherein the configuring comprises: configuring the parameter of the batch convolution operation based on a first parameter of the weight matrix for the second convolutional layer, and configuring the parameters of the input tensor based on a second parameter of the weight matrix for the second convolutional layer and a first parameter of direct memory accesses DMAs where the output tensor of the first convolutional layer is stored; and performing batch convolution operation to the configured input tensor of the first convolutional layer, and configuring output parameters of the first convolutional layer based on a third parameter of the weight matrix for the second convolutional layer and a second parameter of the DMAs, such that a format of the output tensor of the first convolutional layer is consistent with a format of the weight matrix for the second convolutional layer; wherein each channel of the output tensor of the first convolutional layer is used as a convolution kernel of the weight matrix for the second convolutional layer.

The above is an overview of the application, and may be simplified, summarized and omitted in detail. Therefore, those skilled in the art should realize that this part is only illustrative, and is not intended to limit the scope of the application in any way. This summary section is neither intended to determine the key features or essential features of the claimed subject matter, nor is it intended to be used as an auxiliary means to determine the scope of the claimed subject matter.

### BRIEF DESCRIPTION OF DRAWINGS

Through the following detailed description in conjunction with the accompanying drawings and the appended claims, those skilled in the art will more fully understand the above and other features of the content of this application. It can be understood that these drawings and detailed description only depict several exemplary embodiments of the content of the present application, and should not be considered as limiting the scope of the content of the present application. By referring to the drawings, the content of this application will be explained more clearly and in detail.

FIG. 1 shows a schematic diagram of data processing of a convolutional neural network 100.

FIG. 2 shows a part of a process of tensor operation performed by a convolutional neural network according to an embodiment of the present application.

FIG. 3 and FIG. 4 show data distribution ways when using convolutional neural networks for data processing according to different embodiments of the present application, respectively.

### DETAILED DESCRIPTION OF THE INVENTION

In the following detailed description, reference is made to the drawings constituting a part of the specification. In the drawings, unless the context dictates otherwise, similar symbols usually indicate similar components. The illustrative embodiments described in the detailed description, drawings, and claims are not meant to be limiting. Without departing from the spirit or scope of the subject matter of the present application, other implementation modes can be adopted and other changes can be made. It can be understood that various aspects of the content of the application generally described in the application and illustrated in the drawings can be configured, replaced, combined, and designed with various different configurations, and all of these clearly constitute part of the content of the application.

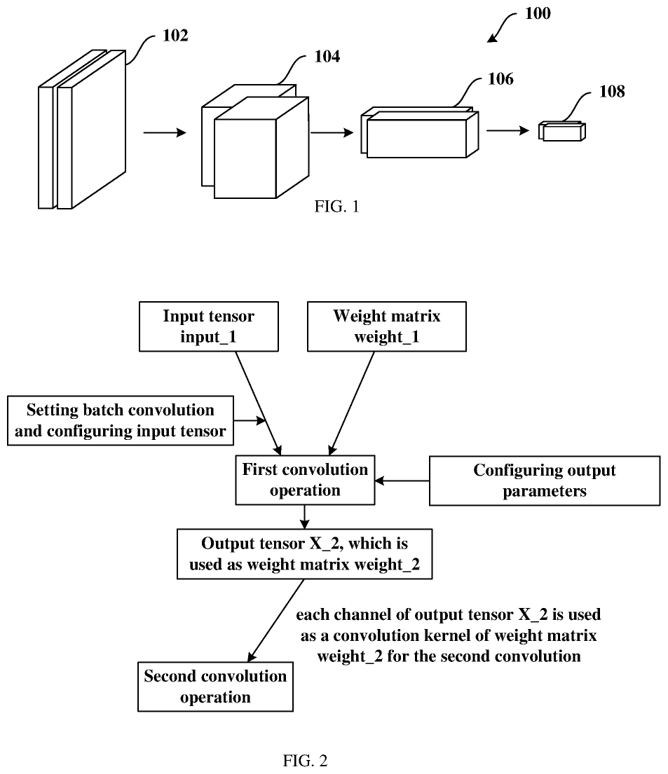

FIG. 1 shows a schematic diagram of data processing of a convolutional neural network 100. The input data 102 of the convolutional neural network 100 is subjected to operations such as convolution, pooling, or activation, etc., intermediate layer feature 104 and intermediate layer feature 106 are sequentially extracted, and finally, output data 108 is obtained. As shown in FIG. 1, during the process of data processing of the convolutional neural network 100, the size of the processed data may change. In FIG. 1, the processed data has 4 dimensions (batch size, width, height and number of channels), but the present application is not limited thereto. For example, the batch size of the input data 102 can be the number of included images, the width and height of the input data 102 are the width and height of the images, and the number of channels of the input data 102 is 3, which represents that an image has, for example, 3 color channels of red, green and blue. From the input data 102 to intermediate layer features 104 and 106, and finally to the output data 108, the dimensions (e.g., width, height, and number of channels) of the data may vary in size.

It can be seen that in the convolutional neural network 100 shown in FIG. 1, at least two feature extraction processes are included. In practical applications, especially in artificial intelligence-related application scenarios, data may be sequentially subjected to multiple feature extractions. Feature extraction may adopt linear mapping methods such as convolution operations or matrix multiplication operations. In the case of using convolution operations to realize the previous and subsequent, i.e. two linear mappings, the output feature of the previous convolution operation may be used as the weight matrix of the subsequent convolution operation. Since the format of the output feature may not be the same as the format of the weight matrix, for example, the output feature may use NHWC, NCHW, CNHW or CHWN (wherein N represents batch size, C represents number of channels, H represents height, W represents width) and other formats for distribution, and the distribution of the weight matrix is related to grouping of the weight matrix and hardware configuration. Therefore, if the output feature needs to be used as the weight matrix of the subsequent convolution operation, additional data format conversion is required.

In order to solve the above problem, the inventors of the present application have designed a data configuration, access and operation mechanism for a convolutional neural network, which can avoid additional data format conversion operations and additional storage operations required for conversion, thus greatly improving the data processing efficiency of the convolutional neural network.

Specifically, in the convolutional neural network of the embodiments of the present application, each convolutional layer can perform a convolution operation to the input data, tensor or feature data, for example, a tensor subjected to convolution and a weight matrix undergoes a convolution operation. Therein, the weight matrix of the convolution operation may include multiple convolution kernel groups, and each convolution kernel group may include multiple convolution kernels. In some embodiments, multiple convolution kernels in the same convolution kernel group can be processed at the same time. It should be noted that, in the following, the tensor subjected to convolution is referred to as “input tensor”, and the result of the convolution is referred to as “output tensor”, but the wording “input” and “output” does not require a tensor to contain features that the tensor is actually subjected to an input or output transmission operation.

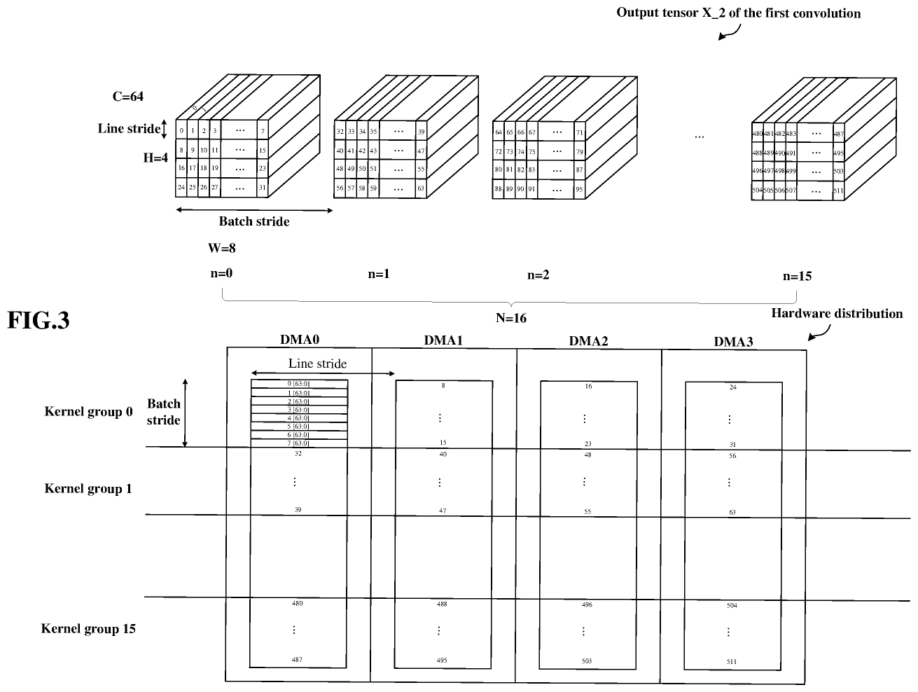

FIG. 2 shows a part of a process of tensor operation performed by a convolutional neural network according to an embodiment of the present application. It should be noted that FIG. 2 only uses two convolution operations as an example to illustrate the tensor operation that a convolutional neural network may perform, but in practical applications, depending on the actual operation needs, a convolutional neural network may perform more times of convolution operations. In addition, in an interval between two convolution operations, a convolutional neural network may include other conventional operation of neural networks, such as pooling, activation, batch normalization, etc.

As shown in FIG. 2, the part of tensor operation process performed by the convolutional neural network may include two convolution operations. In the first convolution operation, input tensor input_1 and weight matrix weight_1 are subjected to a convolution operation and obtain output tensor X_2. The output tensor X_2 of the first convolution operation is used as weight matrix weight_2 for the second convolution operation, and each channel of the output tensor X_2 is used as a convolution kernel of the weight matrix weight_2.

In order to avoid the format conversion operation between the output tensor X_2 and the weight matrix weight_2, in an embodiment of the present application, the first convolutional layer is set to a batch convolution mode, configure a parameter of a batch convolution operation based on a related parameter of the weight matrix weight_2 for the second convolutional layer; and, configure parameters of the input tensor input_1 based on another related parameter of the weight matrix weight_2 and a parameter of direct memory accesses DMAs where the output tensor X_2 is stored, so that the format of the input tensor input_1 can match with the configuration of the buffer space for buffering the output tensor X_2. In an embodiment, the configuration operation can be implemented by a software configuring a register. In addition, the embodiments of the present application also configure output parameters of the first convolutional layer, such as the memory distribution format of the output tensor X_2, based on another related parameter of the weight matrix weight_2 for the second convolutional layer and another parameter of the DMAs, such that the memory distribution format of the output tensor X_2 can match with the format of the weight matrix weight_2, thereby the output tensor X_2 can be directly accessed in the format of the weight matrix weight_2. In some embodiments, the aforementioned buffer refers to DMA buffers used in convolution operations.

That is to say, in order to avoid additional format conversion overhead in the two convolution operations, it is necessary to configure the input and output of the first convolution operation. Specifically, in the case where a neural network including at least two convolutional layers, the two convolutional layers sequentially using respective weight matrices weight_1 and weight_2 for performing convolution operations, and at least the output tensor X_2 of the first convolutional layer can be stored on direct memory accesses DMAs, in order to perform two convolution operations corresponding to the two convolutional layers, the following settings need to be performed: the input tensor input_1 of the convolution operation of the first convolutional layer is configured so that the input tensor input_1 conforms to parameters of the input tensor input_1 used for the first convolutional layer, the parameters of the input tensor input_1 are determined based on a parameter of the weight matrix weight_2 used by the second convolutional layer and a parameter of the DMAs, and the configuration operation does not change the memory distribution of the input tensor input_1; the first convolutional layer is set to a batch convolution mode, and a parameter of the batch convolution operation corresponds to a parameter of the weight matrix weight_2 for the second convolutional layer; in the first convolutional layer, the input tensor input_1, configured based on the parameters of the input tensor input_1, is subjected to a convolution operation with the weight matrix weight_1 used by the first convolutional layer to obtain the output tensor X_2 of the first convolutional layer; the output tensor X_2 of the first convolutional layer is stored based on a parameter of the weight matrix weight_2 used by the second convolutional layer and a parameter of the DMAs, so that the memory distribution of the output tensor X_2 of the first convolutional layer matches with memory distribution of the weight matrix weight_2 for the second convolutional layer, and the output tensor X_2 of the first convolutional layer is distributed on multiple corresponding DMAs; in the second convolutional layer, the output tensor X_2 of the first convolutional layer and another tensor to be convoluted are subjected to another convolution operation, wherein the output tensor X_2 of the first convolutional layer is used as the weight matrix weight_2 for the second convolutional layer, and each channel of the output tensor X_2 of the first convolutional layer is used as a convolution kernel of the weight matrix weight_2 for the second convolutional layer.

It can be understood that the setting of the parameter of the batch convolution operation may be combined and reflected in the first convolution operation, or may be set separately before the first convolution operation. In some embodiments, the setting of the parameter of the batch convolution operation and the first convolution operation can be embodied in the same line of code, in which the first convolution operation is performed with the parameter of the batch convolution; In some other embodiments, the parameter of the batch convolution may be set before the first convolution operation. The present application does not limit the manners in which the batch convolution of the first convolution operation is set to a batch convolution mode. In the following, the data processing method for a convolutional neural network of the present application will be further described in combination with embodiments.

### Embodiment 1

In this embodiment, multiple convolution operations can be applied to the self-attention module of a Transformer or a BERT model of natural language processing. The self-attention module can calculate the attention (i.e., correlation) between each word in two sentences, which includes at least the following two-step matrix multiplication. For example, each sentence can be represented by a two-dimensional array, wherein each word may be represented by a one-dimensional vector. In the first matrix multiplication operation, the two sentences are respectively linearly mapped, and the two arrays corresponding to the two sentences are respectively mapped to spaces of the same dimension through matrix multiplication. Then, in the second convolution operation, in the mapped space, the two sentences are subjected to matrix multiplication so that the correlation between the words in the two sentences can be calculated.

In terms of operation results, the aforementioned matrix multiplication is equivalent to convolution operation using a convolution kernel of size 1*1 (also referred to 1*1 convolution). Therefore, the matrix multiplication can be replaced by a 1*1 convolution operation. That is to say, both of the two matrix multiplication operations can be realized by convolution operations. Therein, an output result of the first convolution operation (linear mapping of two sentences) is used as the weight matrix for the second convolution operation to participate in the second convolution operation. In order for the output result of the first convolution operation to match with the weight matrix in the second convolution operation in format, the tensor convoluted in the first convolution operation can be configured. It can be understood that, such configuration may not necessarily change the memory distribution of the tensor to be convoluted in hardware, and does not require additional access operations, but only changes the indexing of the tensor to be convoluted in the convolution operation. For the sake of illustration, in the following examples, length of the tensor in each dimension (that is, an axis of the tensor) is represented by a certain value, but those skilled in the art can understand that these values do not constitute any limitation to this application. It can be understood that this application only elaborates on the situation where the result of the first convolution operation is used as the weight matrix for the second convolution operation, and the technical solution of this application does not limit the source of the tensor subjected to convolution in the second convolution operation. The embodiments only exemplarily list a tensor source in a situation in natural language processing. In addition, the convolution operation in the above example is a 1*1 convolution operation, but those skilled in the art can understand that the convolution operation in this application can be other n*m convolution operations (both n and m are greater than 1), depending on practical applications and data processing needs.

Object to be operated: In this example, each sentence includes 512 words, and each word is represented by a one-dimensional vector with a length of 768. In the convolution operation, each sentence can be represented as an input tensor input_1 containing 512*768 elements, that is, it can be a 2-dimensional tensor with a size of [512,768], or a 3-dimensional tensor with a size of [1,512,768], or 4-dimensional tensor of size [1,1,512,768], and tensors where order of axes of the above tensors are changed, etc. It can be understood that as long as the total number of elements remains unchanged and each word is a channel of a tensor, the sentence can be represented as [batch size=1, height=1, width=512, number of channels=768]. That is to say, the input tensor input_1 can have two axes, and the lengths of the axes correspond to the number of channels and the width, respectively; the input tensor input_1 can have three axes, and the lengths of the axes correspond to the number of channels, the width and the height respectively; the input tensor input_1 can have four axes, and the lengths of the axes correspond to the number of channels, the width, the height and the batch size, respectively.

The weight matrix weight_1 is used for the first convolution operation, and the format of the weight matrix weight_1 corresponds to the format of the input tensor input_1 (that is, the two can perform convolution operations). The input tensor input_1 can be linearly mapped into a 64-dimensional space using the weight matrix weight_1. The specific parameters of these tensors are shown in Table 1-1 below.

TABLE 1-1

| input tensor | | weight matrix | | operation | |
|---|---|---|---|---|---|
| input_1 | | weight_1 | | information | |
| Parameter | Value | Parameter | Value | Parameter | Value |
| Batch size | 1 | Number of | 64 | Number of | 4 Byte |
| | | convolution | | bytes | |
| | | kernels | | occupied by | |
| | | (number of | | each element | |
| | | output | | in the | |
| | | channels) | | convolution | |
| Height | 1 | Each convolution | | | |
| | | kernel | | | |
| | | kernel_1 | | | |
| Width | 512 | Height | 1 | | |
| Number of | 768 | Width | 1 | | |
| channels | | | | | |
| Format | NHWC | Number of | 768 | | |
| | | input | | | |
| | | channels | | | |

Target: After the first convolution operation of the input tensor input_1 and the weight matrix weight_1, the obtained output tensor X_2 will be used as the weight matrix weight_2 for the second convolution operation. Therein, each channel of the output tensor X_2 is a convolution kernel of the weight matrix weight_2. In the implementation target of the technical solution, the distribution of the weight matrix weight_2 for the second convolution operation on the DMAs is shown as Table 1-2 below. It can be understood that the distribution of the weight matrix weight_2 on the DMAs can be predetermined according to the actual situation of available hardware resources.

TABLE 1-2
weight matrix weight_2 for the second convolution operation

| Parameter | Value |
|---|---|
| Number of used DMAs | 4 |
| Buffer size of a DMA | 32768 Byte |
| Number of convolution kernels | 8 |
| of each convolution kernel group | |
| distributed on one of the DMAs | |
| Number of convolution kernel | 16 |
| groups | |

Input configuration: As mentioned above, in order to make the distribution of the output tensor X_2 obtained by the first convolution operation on DMAs match the format of the weight matrix weight_2 shown in Table 1-2, it is necessary to perform configuration to the input tensor input_1 of the first convolution operation. Specifically, the input tensor input_1 can be configured with the parameters shown in Table 1-3, that is, the product of the batch size, height and width of the input tensor input_1 after configuration and the product of the batch size, height and width of the input tensor input_1 before configuration are equal. Preferably, in the configuration parameters of the input tensor input_1, the height of the input tensor input_1 is the same as a number of used DMAs, and the width of the input tensor input_1 is the same as a number of convolution kernels of each convolution kernel group distributed on one of the DMAs.

TABLE 1-3
Configuration parameters of input tensor
input_1 of the first convolution operation

| Parameter | Value |
|---|---|
| Batch size | 16 |
| Height | 4 |
| Width | 8 |
| Number of channels | 768 |
| Batch size * Height * Width | 16 * 4 * 8 = 1 * 1 * 512 |
| Format | NHWC |

It can be understood that the memory layout of the input tensor input_1 remains unchanged, and each channel of the input tensor input_1 after configuration still corresponds to a corresponding channel of the input tensor input_1 before configuration, and the configuration operation does not destroy the completeness of each channel.

It can be understood that, corresponding to the batch size of the input tensor input_1, the first convolution operation is in a batch convolution mode. In some embodiments, a parameter of the batch convolution operation is configured based on a parameter of the weight matrix weight_2 for the second convolution. Preferably, batch number of the batch convolution operation is configured according to a number of convolution kernel groups of the weight matrix weight_2. In this embodiment, the batch number of the batch convolution operation is preferably 16, which is the same as the batch size of the input tensor input_1 after configuration.

Based on the above settings, according to the format of the input tensor input_1 and the weight matrix weight_1, parameters of the output tensor X_2 of the first convolution operation are shown in Table 1-4 below. Compared to the Table 1-3 above, it can be seen that each word is mapped from 768 dimensions to a 64-dimensional space, but other parameters before and after the convolution operation remain unchanged, that is, the total number of words remains unchanged (16*4*8=1*1*512).

TABLE 1-4
Output tensor X_2 of the first convolution operation

| Parameter | Value |
|---|---|
| Batch size | 16 |
| Height | 4 |
| Width | 8 |
| Number of channels | 64 |

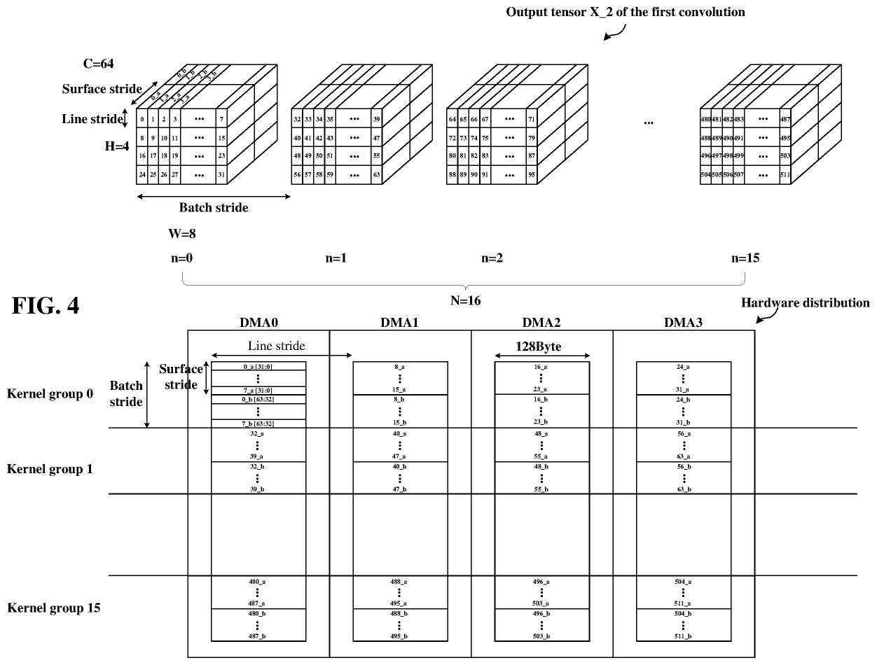

Output configuration: Referring to FIG. 3, in the first convolution operation, the parameters of the output tensor X_2 (the parameters need to be configured are shown in Table 1-5 below, that is, batch stride and line stride) shall be configured, such that the distribution of the output tensor X_2 on the DMAs conforms to the format of the weight matrix weight_2. When configuring, 1) the distribution of the output tensor X_2 on the DMAs can be made to conform to the distribution of weight_2 on the plurality of DMAs; 2) on each DMA, different convolution kernels of each convolution kernel group are continuously distributed; 3) on each DMA, the distribution of different convolution kernel groups on the DMA is continuous. Wherein, the aforementioned distribution on DMAs means that data is stored in the DMAs. Thus, the configured output tensor X_2 can be used for the second convolution operation.

Therein, regarding the feature that the distribution of the output tensor X_2 conforms to the distribution of weight_2 on a plurality of DMAs, specifically, in this embodiment, line stride can be configured based on a DMA buffer size. For example, the line stride can be made equal to the DMA buffer size. Accordingly, in the data blocks of the output tensor X_2, the data at different Hs can be distributed on different DMAs, which matches with the situation that weight_2 is distributed on a plurality of DMAs. Specifically, in the example shown in FIG. 3, the line stride is configured as 32768 Byte, which is equal to the buffer size of each DMA. This means that in the data blocks of the output tensor X_2, under the same N, W, C index, the location difference of data at adjacent Hs in the memory distribution is configured as 32768Byte. For example, in the data blocks of the output tensor X_2, the location difference between the data at C=0 in block n=0 (referred to as block 0) and the data at C=0 in block 8 in the memory distribution is configured to be equal to a DMA buffer size. Similarly, the location difference between the data at C=1 in block 0 and the data at C=1 in block 8 in the memory distribution is also configured to be equal to a DMA buffer size, and so on. Accordingly, block 0, block 8, block 16 and block 24 are configured to be distributed on different DMAs.

In the case that the height of the output tensor X_2 is 4, and the line stride is configured to be equal to the buffer size of each DMA, the output tensor X_2 is distributed on 4 DMAs, that is, the buffer space of each DMA buffers ¼ of all elements of the output tensor X_2 (which equals to line stride). In practical applications, according to actual available hardware conditions and resources, the DMA buffer size may be other appropriate values, and is not limited to the values in this embodiment. Generally speaking, the data volume of the output tensor X_2 buffered in the buffer space of each DMA needs to be less than or equal to the data volume that the DMA can buffer. Preferably, in this embodiment, the data volume of the output tensor X_2 buffered in the buffer space of each DMA is 16*8*64*4Byte=32768Byte, which is equal to the data volume that the DMA can buffer.

TABLE 1-5
output tensor X_2 of the first convolution operation

| Parameter | Value |
|---|---|
| Batch stride | 2048 Byte = 8 * 64 * 4 Byte |
| Line stride | 32768 Byte |

In addition, regarding the feature that on each DMA, the distribution of different convolution kernels in each convolution kernel group is continuous on the DMA, specifically, in the output tensor X_2, data blocks at same height H but different widths Ws (such as data block 0, data block 1, etc.) correspond to different convolution kernels. Under the distribution rule of NHWC, data blocks at same height H but adjacent widths Ws are sequentially and continuously distributed on the same DMA (for example, data block 1 is distributed directly following data block 0). In FIG. 3, it can be seen that convolution kernel 0 to convolution kernel 7 are continuous on DMA0, convolution kernel 8 to convolution kernel 15 are also continuous on DMA1, and the distribution of other convolution kernels is similar. Preferably, according to the hardware design of DMA, the distribution of elements in each convolution kernel may be in reverse order, that is, the elements in each convolution kernel are distributed in the order of [63:0].

In addition, regarding the feature that on each DMA, the distribution of different convolution kernel groups is continuous, specifically, in this embodiment, the batch stride can be configured based on a space occupied by convolution kernels of a convolution kernel group distributed on one DMA, for example, making the batch stride of the output tensor X_2 (in the data blocks at adjacent Ns of the output tensor X_2, the location difference of the data at the same width W, height H and number of channel C in the memory distribution) be equal to a space occupied by convolution kernels of a convolution kernel group distributed on one DMA (batch_stride=num_kernel_per_group_dma*num_kernel_1*element_space). For example, the location difference of data at the corresponding positions of data block 32 and data block 0 in the memory distribution is exactly the space occupied by data block 0 to data block 7. That is to say, on DMA0, the starting position of the convolution kernel of data block 32 is directly adjacent to the end position of data block 7; on DMA1, the starting position of data block 40 is directly adjacent to the end position of data block 15, and the distribution of other data blocks is also similar.

It can be understood that in practical applications, the buffer space that can be used to store the output tensor X_2 shall be equal to or larger than the data volume of the output tensor X_2, so that the problem of data overflow will not occur. In this case, the number of DMAs that can be used for the buffer space can be selected according to actual needs, for example, 2, 4, 8 or more DMAs can be selected. Accordingly, the size of the corresponding allocated buffer space of each DMA can also be determined, but it should be greater than or equal to the total data volume desired to be distributed on one DMA.

### Embodiment 2

In this embodiment, parameters of input tensor input_1, weight matrix for the first convolution operation weight_1, output tensor X_2, and weight matrix for the second convolution operation weight_2 are the same as those in Embodiment 1, but in terms of hardware implementation, DMAs can have different data width (less than the data width in Embodiment 1), as shown in Table 2-1 below.

TABLE 2-1
weight matrix weight_2 for the second convolution operation

| Parameter | Value |
|---|---|
| Data width on a DMA | 128 Byte |

However, the data width of each channel of the output tensor X_2 of the first convolution operation is 4Byte*64=256Byte=2*128Byte, which is larger than the data width on a DMA. That is to say, the former part and latter part (former 32 bits and latter 32 bits) of each channel need to be distributed in the DMAs in order, rather than being distributed together. Therefore, on the basis of the configuration in Embodiment 1, parameters shown in Table 2-2 below also need to be configured.

TABLE 2-2
output tensor X_2 of the first convolution operation

| Parameter | Parameter |
|---|---|
| Surface stride | 1024 Byte = 128 Byte * 8 |

Referring to FIG. 4, under the above configuration, due to the additional setting of the surface stride (each data block is divided into multiple sub-data blocks in the direction of the C-axis for sequential distribution, and surface stride is the location difference of the data at the corresponding positions in the former and latter sub-blocks in the memory distribution), the distribution of the former sections of multiple channels and the latter sections of multiple channels of the output tensor X_2 of a same kernel group on a DMA is continuous in the DMA.

Taking FIG. 4 as an example, without additionally setting a surface stride, the surface stride of the data block of the output tensor X_2 (hereinafter referred to as: default surface stride) would be a space occupied by one surface (former sub-block or latter sub-block, in the case of being divided into more sub-clocks, correspondingly multiple surfaces are included), that is, a space occupied by data block 0_a to data block 31_a, which is also, 32 times of a space occupied by the data block 0_a. Since the present application sets a line stride in the overall solution, the data at different rows of a surface are distributed on multiple DMAs (in this embodiment, four DMAs), and a space occupied by a surface on a single DMA is ¼ of the default surface stride. Provided that a distribution is performed according to the default surface stride, on a single DMA, there will be portion not filled with data between the second surface and the first surface, which will result in discontinuity of the weight matrix weight_2 corresponding to the output tensor X_2 in a DMA. Continuity may be achieved by configuring surface stride.

Specifically, the surface stride can be configured based on a surface size of convolutional kernels of one convolution kernel group of the weight matrix weight_2 distributed on one DMA. As shown in FIG. 4, convolution kernels of one convolution kernel group of the weight matrix weight_2 distributed on one DMA constitutes a convolution kernel subgroup, and each convolution kernel group includes a convolution kernel subgroup stored on one DMA, for example, convolution kernels 0-7 constitute a convolution kernel subgroup on DMA0, convolution kernels 8-15 constitute a convolution kernel subgroup on DMA1, and so on. In the present embodiment, the surface stride is set according to a surface size of a convolution kernel subgroup of the weight matrix weight_2. Specifically, the surface size represents a space occupied by continuously distributed same indexed sections of multiple convolution kernels of one convolution kernel subgroup. As shown in FIG. 4, indexed section [31:0] of convolution kernel 0 to indexed section [31:0] of convolution kernel 7 (that is, 0_a to 7_a) are continuously distributed on a DMA and form a surface, whose surface size is a space occupied by this continuous distribution. In one embodiment, the corresponding indexed section [31:0] of each convolution kernel has the same data width as a DMA, therefore, the surface size is equal to a product of the data width on a DMA (in the embodiment shown in FIG. 4, 128Byte) and a number of convolution kernels of one convolution kernel group distributed on one DMA (in the embodiment shown in FIG. 4, 8).

In the embodiment shown in FIG. 4, in each convolution kernel group, the former half of each convolution kernel (that is, 0_a to 7_a) can be firstly distributed, and the latter half (that is, 0_b to 7_b) can be distributed directly following the former half. Such configuration does not affect the continuous distribution of different convolution kernels of a same convolution kernel group on a DMA, nor does it affect the continuous distribution of different convolution kernel groups on a DMA. Preferably, according to the hardware design of the DMAs, the distribution of elements in each convolution kernel may be in reverse order. In other words, in a convolution kernel group, the former half of each convolution kernel may be distributed in the order of [31:0], and the latter half may be distributed in the order of [63:32]. It can be understood that, according to specific configurations, it is not limited to the description of the order of “former” and “latter” above. It can be understood that when the data width on a DMA is other values, each convolution kernel can be divided into multiple parts for distribution in a similar manner. For example, when the DMA data width is ¼ of the data width of the output tensor X_2, each convolution kernel needs to be divided into 4 parts for distribution.

It can be seen that in the two basic scenarios shown in Embodiment 1 and Embodiment 2, each convolution kernel group has a convolution kernel subgroup stored on a DMA, and the corresponding convolution kernel subgroups of the plurality of convolution kernel groups on a same DMA are stored sequentially. For example, for DMA0, after the first convolution kernel subgroup of the first convolution kernel group is stored, the first convolution kernel subgroup of the second convolution kernel group is stored on the DMA.

### Embodiment 3

In this embodiment, the application scenario and/or application manner of the convolutional neural network is similar to that of Embodiment 1. Firstly, input tensor input_1 performs a first convolution operation with weight matrix weight_1, and obtains output tensor X_2 as weight matrix weight_2 for a second convolution operation, wherein each channel of the output tensor X_2 is a convolution kernel of the weight matrix weight_2. In addition, in Embodiment 3, parameters of the input tensor input_1 and the weight matrix weight_1 are still as shown in Table 1-1.

But different from Embodiment 1, in Embodiment 3, according to the implementation target of the technical solution, distribution of the weight matrix weight_2 for the second convolution operation on DMAs is shown as Table 3-1. Specifically, the number of used DMAs is increased from 4 in Embodiment 1 to 16, and the number of convolution kernels of each convolution kernel group distributed on one of the DMAs and the number of convolution kernel groups are decreased from 8 and 16 to 4 and 8, respectively.

TABLE 3-1
weight matrix weight_2 for the second convolution operation

| Parameter | Value |
|---|---|
| Number of used DMAs | 16 |
| Buffer size of a DMA | 8192 Byte |
| Number of convolution kernels | 4 |
| of each convolution kernel group | |
| distributed on one of the DMAs | |
| number of convolution kernel | 8 |
| groups | |

In order to make the distribution of the output tensor X_2 of the first convolution operation on the DMAs match with the format of the weight matrix weight_2 as shown in Table 3-1, it is necessary to configure the input tensor input_1 of the first convolution operation. Therein, the input tensor input_1 can be configured with the parameters shown in Table 3-2. As illustrated in Embodiment 1, the memory layout of the input tensor input_1 may be unchanged, and the first convolution operation reads and operates the input tensor input_1 in the format of the configured input tensor input_1.

TABLE 3-2
Configuration parameters of input tensor
input_1 of the first convolution operation

| Parameter | Value |
|---|---|
| Batch size | 8 |
| Height | 16 |
| Width | 4 |
| Number of channels | 768 |
| Batch size * Height * Width | 8 * 16 * 4 = 1 * 1 * 512 |
| Format | NHWC |

In the first convolution operation, parameters of the output tensor X_2 (parameters shown in Table 3-3) are configured so that the distribution of the output tensor X_2 on the DMAs conforms to the distribution format of the weight matrix weight_2. Thus, the configured output tensor X_2 can be used for the second convolution operation.

TABLE 3-3
Output tensor X_2 of the first convolution operation

| Parameter | Value |
|---|---|
| Batch stride | 1024 Byte = 4 * 64 * 4 Byte |
| Line stride | 8192 Byte |

### Embodiment 4

In this embodiment, the application scenario and/or application manner of the convolutional neural network is similar to that of Embodiment 1. Firstly, input tensor input_1 performs a first convolution operation with weight matrix weight_1, and obtains output tensor X_2 as weight matrix weight_2 for a second convolution operation, wherein each channel of the output tensor X_2 is a convolution kernel of the weight matrix weight_2. In addition, in Embodiment 4, parameters of the input tensor input_1 and the weight matrix weight_1 are still as shown in Table 1-1.

But different from Embodiment 1, in Embodiment 4, according to the implementation target of the technical solution, distribution of the weight matrix weight_2 for the second convolution operation on DMAs is shown as Table 4-1. Specifically, the number of used DMAs is 16, and the number of convolution kernels of each convolution kernel group distributed on one of the DMAs and the number of convolution kernel groups are 16 and 2, respectively.

TABLE 4-1
weight matrix weight_2 for the second convolution operation

| Parameter | Value |
|---|---|
| Number of used DMAs | 16 |
| Buffer size of a DMA | 8192 Byte |
| Number of convolution | 16 |
| kernels of each convolution | |
| kernel group distributed on | |
| one of the DMAs | |
| number of convolution | 2 |
| kernel groups | |

In order to make the format of the output tensor X_2 of the first convolution operation match with the format of the weight matrix weight_2 (as shown in Table 4-1), it is necessary to configure the input tensor input_1 of the first convolution operation. Therein, the input tensor input_1 can be configured with the parameters shown in Table 4-2, which is, a height of the input tensor can be configured based on the number of DMAs; a width of the input tensor can be configured based on the number of convolution kernels of each convolution kernel group distributed on one of the DMAs. As illustrated in Embodiment 1, the memory layout of the input tensor input_1 may be unchanged, and the first convolution operation operates the configured input tensor input_1.

TABLE 4-2
Configuration parameters of input tensor
input_1 of the first convolution operation

| Parameter | Value |
|---|---|
| Batch size | 2 |
| Height | 16 |
| Width | 16 |
| Number of channels | 768 |
| Batch size * Height * Width | 2 * 16 * 16 = 1 * 1 * 512 |
| Format | NHWC |

In the first convolution operation, parameters of the output tensor X_2 are configured, (as shown in Table 4-3 below), that is, a batch stride and a line stride of the output tensor of the first convolutional layer are configured according to a space occupied by convolution kernels of each convolution kernel group distributed on one of the DMAs and the buffer size of each of the DMAs, so that the distribution of the output tensor X_2 on the DMAs conforms to the distribution format of the weight matrix weight_2. Thus, the configured output tensor X_2 can be used for the second convolution operation.

TABLE 4-3
Output tensor X_2 of the first convolution operation

| Parameter | Value |
|---|---|
| Batch stride | 4096 Byte = 16 * 64 * 4 Byte |
| Line stride | 8192 Byte |

### Embodiment 5

In this embodiment, the application scenario and/or application manner of the convolutional neural network is similar to that of Embodiment 1. Firstly, input tensor input_1 performs a first convolution operation with weight matrix weight_1, and obtains output tensor X_2 as weight matrix weight_2 for a second convolution operation, wherein each channel of the output tensor X_2 is a convolution kernel of the weight matrix weight_2. In addition, in Embodiment 5, the parameters of the input tensor input_1 and the weight matrix weight_1 are as shown in Table 5-1, which are different from the parameters shown in Table 1-1.

TABLE 5-1

| input tensor | | weight matrix | | operation | |
|---|---|---|---|---|---|
| input_1 | | weight_1 | | information | |
| Parameter | Value | Parameter | Value | Parameter | Value |
| Batch size | 1 | Number of | 64 | Number of | 2 Byte |
| | | convolution | | bytes | |
| | | kernels | | occupied by | |
| | | (number of | | each element | |
| | | output | | in the | |
| | | channels) | | convolution | |
| Height | 2 | Each convolution | | | |
| | | kernel | | | |
| | | kernel_1 | | | |
| Width | 256 | Height | 1 | | |
| Number of | 64 | Width | 1 | | |
| channels | | | | | |
| Format | NHWC | Number of | 64 | | |
| | | input | | | |
| | | channels | | | |

In Embodiment 5, according to the implementation target of the technical solution, the desired distribution of the weight matrix weight_2 for the second convolution operation on the DMAs is shown in Table 5-2. Specifically, the number of used DMAs is 16, and the number of convolution kernels of each convolution kernel group distributed on one of the DMAs and the number of convolution kernel groups are 16 and 2, respectively.

TABLE 5-2
weight matrix weight_2 for the second convolution operation

| Parameter | Value |
|---|---|
| Number of used DMAs | 16 |
| Buffer size of a DMA | 4096 Byte |
| Number of convolution | 16 |
| kernels of each convolution | |
| kernel group distributed on | |
| one of the DMAs | |
| Number of convolution | 2 |
| kernel groups | |

In order to make the distribution of the output tensor X_2 of the first convolution operation on the DMAs match with the format of the weight matrix weight_2 shown in Table 5-2, it is necessary to configure the input tensor input_1 of the first convolution operation. Therein, the input tensor input_1 can be configured with the parameters shown in Table 5-2, that is, the product of batch size, height and width of the input tensor input_1 after configuration is equal to the product of batch size, height and width of the input tensor input_1 before configuration. Preferably, in the configuration parameters of the input tensor input_1, the height of the input tensor input_1 is the same as a number of used DMAs, and the width of the input tensor input_1 is the same as a number of convolution kernels of each convolution kernel group distributed on one of the DMAs.

TABLE 5-3
Configuration parameters of input tensor
input_1 of the first convolution operation

| Parameter | Value |
|---|---|
| Batch size | 2 |
| Height | 16 |
| Width | 16 |
| Number of channels | 64 |
| Batch size * Height * Width | 2 * 16 * 16 = 1 * 2 * 256 |
| Format | NHWC |

In the first convolution operation, parameters of the output tensor X_2 shown in Table 5-4 below are configured, that is, a batch stride and a line stride of the output tensor of the first convolutional layer are configured according to a space occupied by convolution kernels of each convolution kernel group distributed on one of the DMAs and a buffer size of each of the DMAs, respectively, so that the distribution of the output tensor X_2 on the DMAs conforms to the distribution format of the weight matrix weight_2. Thus, the configured output tensor X_2 can be used for the second convolution operation.

TABLE 5-4
output tensor X_2 of the first convolution operation

| Parameter | Value |
|---|---|
| Batch stride | 2048 Byte = 16 * 64 * 2 Byte |
| Line stride | 4096 Byte |

It can be understood that, in the foregoing embodiments, the distribution manner of the input and output tensors of the convolution in a memory device is NHWC. In other distribution formats, the method described in this application may shuffle the positions of the corresponding axes of the tensors.

It can be understood that the tensors in the above embodiments represent text, but the data in the tensors can represent other contents, such as images, and the method of the present application does not limit to the type of information represented by the tensors.

It should be noted that the text above only takes two convolution operations as an example to show that the input tensor and the output tensor of the first convolution operation are configured, but aspects of the present application are not limited thereto. Those skilled in the art may adjust the settings of the first convolution operation according to the second convolution operation, or may adjust the settings of the second convolution operation according to the first convolution operation. The present application aims to omit the step of format conversion between the output tensor and the weight matrix, and does not constitute a restriction on the setting relationship between the former and the latter convolutions.

It can be understood that the weight matrix is not limited to the dimension of the matrix being 2. As those skilled in the art can understand, the weight matrix can at least represent the convolution weights for convolution in the neural network, and the convolution can include single-channel convolution and multi-channel convolution. The weight matrix of the convolutional layer can express multiple convolution kernels, and each convolution kernel can include axes of height, width, and number of input channels.

It can be understood that matrix multiplication can be realized through convolution operation of corresponding size. Therefore, the data processing method proposed in the present application can be applied to operations involving matrix multiplication. For example, the output of the first convolution operation is the weight matrix of the second convolution operation, the output of the first convolution operation is the weight matrix of the second matrix multiplication, and the output of the first matrix multiplication is the weight matrix of the second convolution, the output of the first matrix multiplication is the weight matrix of the second matrix multiplication, and so on. It can be understood that other types of operations can be included between two operations (convolution/matrix multiplication-convolution/matrix multiplication), such as pooling, batch normalization, activation (such as ReLu), etc.

It can be understood that, the method according to the embodiments of the present application can avoid the operation of converting the format of an output data of a previous operation to the format of a weight matrix in traditional AI accelerators, the present application can avoid the additional read and write operations of the on-chip memory (e.g. SRAM) and the data reorganization of the DMAs caused by the aforementioned operation. The method according to the embodiments of the present application can improve the utilization rate of the on-chip memory and can enhance the overall chip performance.

In some embodiments, the present application also provides some computer program products, including non-transitory computer readable storage medium. The non-transitory computer readable storage medium includes computer executable code for performing the steps described in the above embodiments of the present application.

The embodiments of the present application may be implemented by hardware, software or any combination thereof. The hardware may be implemented by specific logic circuits, and the software may be stored in a memory and executed by appropriate instruction executing systems. For example, the software may be executed by a microprocessor or a specifically designed hardware. Those skilled in the art may understand that the previous apparatus and method of the present application may be implemented by computer-executable instructions and/or control codes contained in the processor. For example, such codes may be provided in storage mediums such as hard disks, CD(s), DVD-ROM(s), programmable memories such as ROM(s), or data mediums such as optical or electrical signal mediums. An apparatus of the present application and its modules may be implemented by hardware circuits including VLSI(s) or gate arrays, semiconductor circuits such as logic circuits or transistors, or programmable hardware devices such as FPGA(s) or PLD(s). An apparatus of the present application may also be implemented by software executable by various processors, or implemented by the combinations of the hardware and software such as firmware.

It should be noted that although several steps of the data processing method for a convolutional neural network are mentioned in the above detailed description, such division is exemplary and not mandatory. Practically, according to the embodiments of the present application, the features and functions of two or more modules described above can be embodied in one step. In contrast, the features and functions of a step described above can be further divided into multiple steps to be embodied.

Those of ordinary skill in the art can understand and implement other changes to the disclosed embodiments by studying the description, the content of the disclosure, the drawings and the appended claims. In the claims, the word “comprise” does not exclude other elements and steps, and the word “a” and “an” do not exclude plurals. In the actual application of this application, one part may perform the functions of multiple technical features cited in the claims. Any reference signs in the claims should not be construed as limiting the scope.

1. A data processing method for a convolutional neural network, wherein the convolutional neural network comprises a first convolutional layer and a second convolutional layer, wherein an output tensor of the first convolutional layer is used as a weight matrix for the second convolutional layer, the data processing method comprising:
setting the first convolutional layer to a batch convolution mode, and configuring a parameter of a batch convolution operation and parameters of an input tensor to be processed by the first convolutional layer; wherein the configuring comprises: configuring the parameter of the batch convolution operation based on a first parameter of the weight matrix for the second convolutional layer, and configuring the parameters of the input tensor based on a second parameter of the weight matrix for the second convolutional layer and a first parameter of direct memory accesses (DMAs) where the output tensor of the first convolutional layer is stored; and
performing batch convolution operation to the configured input tensor of the first convolutional layer, and configuring output parameters of the first convolutional layer based on a third parameter of the weight matrix for the second convolutional layer and a second parameter of the DMAs, such that a format of the output tensor of the first convolutional layer is consistent with a format of the weight matrix for the second convolutional layer; wherein each channel of the output tensor of the first convolutional layer is used as a convolution kernel of the weight matrix for the second convolutional layer.

2. The data processing method according to claim 1, wherein configuring the parameter of the batch convolution operation based on a first parameter of the weight matrix for the second convolutional layer comprises:
configuring a batch number of the batch convolution operation according to a number of convolution kernel groups of the weight matrix.

3. The data processing method according to claim 1, wherein configuring the parameters of the input tensor based on a second parameter of the weight matrix for the second convolutional layer and a first parameter of DMAs comprises:
configuring a width and a height of the input tensor according to a number of convolution kernels of each convolution kernel group distributed on one of the DMAs and a number of the DMAs, respectively.

4. The data processing method according to claim 1, wherein configuring output parameters of the first convolutional layer based on a third parameter of the weight matrix for the second convolutional layer and a second parameter of the DMAs comprises:
configuring a batch stride and a line stride of the output tensor of the first convolutional layer according to a space occupied by convolution kernels of each convolution kernel group of the weight matrix distributed on one of the DMAs and a buffer size of each of the DMAs, respectively.

5. The data processing method according to claim 4, wherein each convolution kernel group of the weight matrix for the second convolutional layer comprises a convolution kernel subgroup stored on one of the DMAs, and
configuring output parameters of the first convolutional layer further comprises:
configuring a surface stride of the output tensor of the first convolutional layer according to a surface size of the convolution kernel subgroup of the weight matrix, wherein the surface size represents a space occupied by continuously distributed same indexed sections of multiple convolution kernels of one convolution kernel subgroup.

6. The data processing method according to claim 1, wherein each convolution kernel group of the weight matrix for the second convolutional layer comprises a convolution kernel subgroup stored on one of the DMAs, and corresponding convolution kernel subgroups of a plurality of convolution kernel groups on the same DMA are stored sequentially.

7. The data processing method according to claim 1, wherein between the first convolutional layer and the second convolutional layer, the convolutional neural network further comprises one or more layers of pooling, batch normalization or activation.

8. The data processing method according to claim 1, wherein a convolution operation of the first convolutional layer and a convolution operation of the second convolutional layer are two linear mappings of a self-attention module of a BERT or a Transformer.

9. The data processing method according to claim 1, wherein the input tensor to be processed by the first convolutional layer has two axes, wherein a length of one of the two axes corresponds to a number of channels of the input tensor, and a length of the other of the two axes corresponds to a width of the input tensor.

10. The data processing method according to claim 1, wherein the input tensor to be processed by the first convolutional layer has three axes, wherein a length of a first one of the three axes corresponds to a number of channels of the input tensor, a length of a second one of the three axes corresponds to a width of the input tensor, and a length of a third one of the three axes corresponds to a height of the input tensor.

11. The data processing method according to claim 1, wherein the input tensor to be processed by the first convolutional layer has four axes, wherein a length of a first one of the four axes corresponds to a number of channels of the input tensor, a length of a second one of the four axes corresponds to a width of the input tensor, a length of a third one of the four axes corresponds to a height of the input tensor, and a length of a fourth one of the four axes corresponds to a batch size of the input tensor.
